(19) United States
(12) Patent Application Publication
(10) Pub. No.: US 2017/0293803 A1
(43) Pub. Date: Oct. 12, 2017

(54) METHOD AND A SYSTEM FOR COMPARING VIDEO FILES

(71) Applicant: YANDEX EUROPE AG, Luzern (CH)

(72) Inventor: Nikita Alekseevich SMETANIN, Ekaterinburg (RU)

(21) Appl. No.: 15/460,637

(22) Filed: Mar. 16, 2017

(30) Foreign Application Priority Data
Apr. 7, 2016 (RU) 2016113166

(51) Int. Cl. G06K 9/00; H04N 21/2747; H04N 21/231

(52) U.S. Cl. CPC G06K 9/00744; H04N 21/23113; H04N 21/2747

(57) ABSTRACT

There is disclosed a method of selecting a candidate video, the candidate video potentially being a near-duplicate of a given video, the given video having a given video duration. The method is executed at an electronic device, the electronic device having access to a video storage. The method comprises: determining a variance parameter, the variance parameter being determined based on the first video duration; receiving, from the video storage, a plurality of candidate videos; selecting a first candidate video from the plurality of candidate videos, the first candidate video having a first candidate video duration; comparing the first candidate video duration with the variance parameter; in response to the first candidate video duration being within the variance parameter, determining that the first candidate video is an actual candidate for being a near-duplicate of the given video.

### CROSS-REFERENCE

The present application claims priority to Russian Patent Application No. 2016113166, filed Apr. 7, 2016, entitled “A METHOD AND A SYSTEM FOR COMPARING VIDEO FILES”, the entirety of which is incorporated herein by reference.

### FIELD

The present technology relates to methods of conducting searches in general and specifically to a method and a system for comparing video files.

### BACKGROUND

It is a well known task, in computer-implemented technologies, to search data. With modern developments in data storage and network technologies, it is sometimes required to search vast amounts of data. A good example is searching the Internet, where for a particular user search query, the search engine searches millions and millions of potentially relevant network resources to identify a subset thereof that are potentially more relevant to the user search query in order to present a ranked list of potentially relevant resources to the user who has submitted the search query.

A particular task in the area of searching is searching video files. For example, in a collection of video resources (such as NETFLIX™ video repository provided by Neflix Inc of Los Gatos, Calif., United States or another online service allowing the user to browse/stream/download video content), it is clearly desirable to provide the user an option to search the video files to identify a particular video file of interest.

In order to enable the search of such video files in a large collection, it is known to generate an index of video files to enable an efficient search thereof. One particular challenge of indexing large collection of video files is identification of duplicate files. Duplicate files can be present for one of multiple reasons, such as different users uploading the same video, near-duplicate copies having been uploaded, same video being available from multiple sources and the like. Some of these duplicates are identical copies of each other (i.e. having the same length and the same content). Others are near duplicates and may differ in length and content (for example, one video file contains an episode of a TV series without commercial, the other one contains the same TV series episode with commercial segments left intact).

One can easily appreciate that identification of full duplicates is a relatively straightforward task and could be easily accomplished via known deduplication techniques employing hashing (as an example). Finding near-duplicates, on the other hand, is a more complicated process and requires direct comparison of original video files or their signatures.

Such search of near-duplicates in a given video collection can take a significant amount of time and requires a significant amount of computing resources (processing power and the like).

There is a known approach disclosed in an article entitled: “Real-Time Near-Duplicate Elimination for Web Video Search with Content and Context” (Xiao Wu, Chong-Wah Ngo, Alexander G. Hauptmann, Hung-Khoon Tan). The article discloses a method that uses time duration to identify a preliminary group of near-duplicate videos. Dominant version identification is performed by analyzing the distribution of time durations. For each dominant version, a seed video, which potentially is the original source from which other videos are derived, is selected. Videos falling within a specified time range, which is the same for all the videos, are considered to be near-duplicate candidates.

There another known approach disclosed in an article entitled: “Elimination of Duplicate Videos in Video Sharing Sites” (Authors: Narednra Kumar S, Murugan S, Krishnavei R, Published: International Conference on Computer Science and Information Technology (ICCSIT'2011) Pattaya December 2011). The disclosed method contemplates that for each query, a dominant version identification is performed by collecting the time duration of all videos. That is, videos having similar time duration are gathered as a set. If ‘d’ is the multiple duration for a query, then videos having duration of ‘d±α’ is gathered, where a can be the range of 2 to 4 sec.

U.S. Pat. No. 8,953,836 discloses systems and methods relating to real-time duplicate detection of video content. Fingerprints can be generated for an uploaded video. The fingerprints can be used to match the uploaded video to a set of matching videos. The set of matching videos can be filtered based on the type of match, and the quality of the match. A unique cluster-id can be generated for the uploaded video containing an upload time, and that unique cluster-id can then be modified to associate the uploaded video with a cluster-id of potential duplicates. Cluster-ids can then be used in the context of a search to filter results that have identical cluster-ids. The benefits in using real-time duplicate detection can better maximize user experiences in a video sharing service that contains potential duplicates of the same content.

### SUMMARY

It is an object of the present technology to ameliorate at least some of the inconveniences present in the prior art.

Developers of the present technology have developed embodiments of the present technology based on their appreciation of at least one shortcoming associated with known approaches to the identification of near-duplicate video files.

Without wishing to be bound by any particular theory, developers of the present technology have developed embodiments thereof based on the premise that the search can be accelerated by excluding certain operations of comparing the potentially near-duplicate videos that are apriori clearly not to be near-duplicates. Hence, the technical problem addressed by embodiments of the present technology is efficient selection of candidates for near-duplicates to be used in actual comparison with the given video for which near-duplicate videos are to be determined. In other words, the process of determining near duplicate video files is split into two stages: (i) selection of candidates and (ii) analysis of so-selected candidates for determining near-duplicate video files (i.e. comparison with the given video file for which near-duplicates are to be determined).

Without wishing to be bound by any particular theory, developers of the present technology have developed embodiments thereof based on the further premise that near-duplicate video files have same or almost the same duration as the given video to which they relate as near-duplicate videos.

As mentioned above, a given collection of video files can have duplicates of two types: completely identical copies of the video file (full duplicates) and copies that have almost identical content, but also have certain modifications—additions or subtractions of video content. The duration of the modified versions (i.e. the duration of the near-duplicates video files) may be same or may slightly differ from the original due to the modifications thereof—such as added content (commercials, announcements, and the like) or removed fragments (for example, movie credits and the like).

As such, developers of the present technology believe that duration similarity between a potential near-duplicate candidate and an original video file is a good indicator of the likelihood of the near-duplicate video candidate indeed being the near-duplicate of the given video file to which the near-duplicate video file relates.

Developers have further appreciated that the magnitude of variations in duration of near-duplicates videos depends on the length of the given video file to which the near-duplicate(s) relate(s). For example, near-duplicate videos of longer videos tend to have greater variation in duration than near-duplicates of shorter videos. That can be due to the fact that more commercials/ads segments can be added to a longer video. By the same token, larger segments can be removed from a comparatively longer video (e.g. credits, intros and the like). As such, developers have appreciated that duration variations of near-duplicates videos of comparatively longer videos are more pronounced than those near-duplicate videos of comparatively shorter videos.

To address the above mentioned problems, developers of the present technology have developed a method of selecting near-duplicate candidates, for a given original video, using a variable time slot threshold (can also be thought of as a “variance template” or a “variance mask”), which threshold is calculated based the duration of the given original video, for which the near-duplicates are to be searched.

In order to do so, a “reference video” (which can be the given original video or a near-duplicate of another video in itself) is selected. Based on the duration of the reference video, the variance template is determined—i.e. acceptable limits of the variation time slot are calculated.

The acceptable limits denote the acceptable variances in duration of near-duplicate candidates compared to the reference video. If the near-duplicate video duration being within the variance template of the reference video, the near-duplicate video is selected as the actual candidate for being the near-duplicate of the reference video.

The process is repeated for other potential near-duplicate video candidates. Those that are determined to be the actual near-duplicate video candidates are actually compared to the reference video to determine if they are indeed near-duplicate videos. The comparison can be done bit-by-bit, by comparing video signatures, by comparing audio tracks or using any other known technique. For example, the comparison can be done using an inverted video-index comprising video-words (i.e. visual words) as keys and identifiers of videos that contain these video-words. In case of the number of matching video-words of a given near-duplicate video candidate and the reference video exceeds a predetermined threshold, they are considered duplicates.

A technical effect of embodiments of the present technology lies in a more efficient and less-resource consuming process of determining near-duplicate videos in a large collection of videos by virtue of efficiently eliminating those potential near-duplicate video candidates that are not likely to be near-duplicates based on the duration thereof being outside of the variance template.

According to a first broad aspect of the present technology, there is provided a method of selecting a candidate video, the candidate video potentially being a near-duplicate of a given video. The given video having a given video duration. The method is executed at an electronic device, the electronic device having access to a video storage. The method comprises: determining a variance parameter, the variance parameter being determined based on the first video duration; receiving, from the video storage, a plurality of candidate videos; selecting a first candidate video from the plurality of candidate videos, the first candidate video having a first candidate video duration; comparing the first candidate video duration with the variance parameter; in response to the first candidate video duration being within the variance parameter, determining that the first candidate video is an actual candidate for being a near-duplicate of the given video.

In some embodiments of the method, the method further comprises comparing the first candidate video with the given video.

In some embodiments of the method, the given video comprises a given video signature and the first candidate video comprising a first candidate video signature; wherein the comparing the first candidate video with the given video comprises comparing the first candidate video signature and the given video signature.

In some embodiments of the method, the comparing the first candidate video signature and the given video signature is executed in a bit-by-bit manner

In some embodiments of the method, the method further comprises comparing at least one of: audio tracks, meta data, and titles for the given video and the first candidate video.

In some embodiments of the method, the method further comprises: selecting a second candidate video from the plurality of candidate videos, the second candidate video having a second candidate video duration; comparing the second candidate video duration with the variance parameter; if the second candidate video duration is outside the variance parameter, determining that the second candidate video is not an actual candidate for being a near-duplicate of the given video.

In some embodiments of the method, the method further comprises: comparing the first candidate video with the given video; not comparing the second candidate video with the given video.

In some embodiments of the method, the variance parameter comprises: as an upper limit of variance, the first video duration; as a lower limit, a value that is the first video duration less a pre-determined variance window.

In some embodiments of the method, the variance parameter comprises: as an upper limit of variance, a value that is the first video duration plus a pre-determined variance window; as a lower limit, a value that is the first video duration less the pre-determined variance window.

In some embodiments of the method, the method further comprises comparing the first candidate video with the given video to determine if the first candidate video being the near-duplicate of the given video.

In some embodiments of the method, in response to the first candidate video being the near-duplicate of the given video, the method further comprises executing at least one action with at least one of: the first candidate video and the given video.

In some embodiments of the method, the selecting the first candidate video from the plurality of candidate videos comprises: ranking the plurality of candidate videos in an order of respective candidate video duration; selecting the first video candidate being a video candidate with a lowest duration.

In accordance with another broad aspect of the present technology, there is provided an electronic device. The electronic device comprises: a communication interface for communication via a communication network with a video storage, the video storage hosting a plurality of videos, a processor operationally connected with the communication interface, the processor configured to: receive, from the video storage, a plurality of candidate videos; a candidate video of the plurality of candidate videos potentially being a near-duplicate of a given video, the given video having a given video duration; determine a variance parameter, the variance parameter being determined based on the first video duration; select a first candidate video from the plurality of candidate videos, the first candidate video having a first candidate video duration; compare the first candidate video duration with the variance parameter; in response to the first candidate video duration being within the variance parameter, determine that the first candidate video is an actual candidate for being a near-duplicate of the given video.

In the context of the present specification, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system configured to implement various embodiments of the present technology.

FIG. 2 depicts a schematic illustration of respective durations of a first video, a second video, a third video and a fourth video, which are stored within the system of FIG. 1.

FIG. 3 depicts a schematic representation of the first video, the second video, the third video and the fourth video with processing data overlaid over them, the processing data as determined by a video indexing application of the system of FIG. 1, the processing data being determined in accordance with embodiments of the present technology.

FIG. 4 depicts a block diagram of a method of selecting near-duplicate video candidates, the method being implemented in accordance with non-limiting embodiments of the present technology and being executable by a video indexing application of the system of FIG. 1.

### DETAILED DESCRIPTION

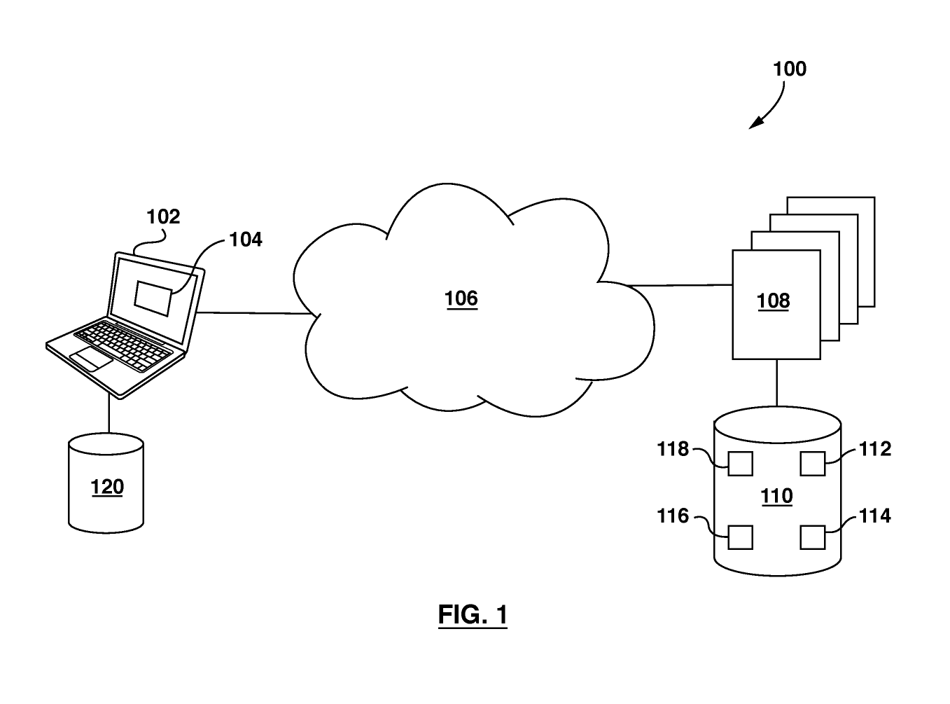

With reference to FIG. 1, there is depicted a system 100, the system implemented according to embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises an electronic device 102. The electronic device 102 is typically associated with a user (not depicted) and, as such, can sometimes be referred to as a “client device”. It should be noted that the fact that the electronic device 102 is associated with the user does not need to suggest or imply any mode of operation—such as a need to log in, a need to be registered or the like.

The implementation of the electronic device 102 is not particularly limited, but as an example, the electronic device 102 may be implemented as a personal computer (desktops, laptops, netbooks, etc.), a wireless communication device (a cell phone, a smartphone, a tablet and the like), as well as network equipment (a router, a switch, or a gateway). Within the depiction of FIG. 1, the electronic device 102 is implemented as the personal computer (desk top).

The electronic device 102 is coupled to a communications network 106. In some non-limiting embodiments of the present technology, the communications network 106 can be implemented as the Internet. In other embodiments of the present technology, the communications network 106 can be implemented differently, such as any wide-area communications network, local-area communications network, a private communications network and the like.

Also coupled to the communications network is a server 108. The server 108 can be implemented as a conventional computer server. In an example of an embodiment of the present technology, the server 108 can be implemented as a Dell™ PowerEdge™ Server running the Microsoft™ Windows Server™ operating system. Needless to say, the server 108 can be implemented in any other suitable hardware and/or software and/or firmware or a combination thereof. In the depicted non-limiting embodiment of present technology, the server 108 is a single server. In alternative non-limiting embodiments of the present technology, the functionality of the server 108 may be distributed and may be implemented via multiple servers.

In alternative embodiments of the present technology, the electronic device 102 and the server 108 can be implemented as part of the same hardware (i.e. a single computing device), in which case the communications network 106 can be implemented as a BUS or the like.

There is also provided a video repository 110. In some embodiments of the present technology, the video repository 110 can be implemented as a storage of a plurality of video files. In alternative embodiments of the present technology, the video repository 110 can be a distributed entity containing a plurality of electronic video files. For example, the video repository 110 can be a conglomeration of some or all of the electronic video files available on various servers (not depicted) within the communications network 106.

Alternatively, the video repository 110 can be a conglomeration of electronic video files available at a particular entity, such as a library or a research institution, as an example. In other words, embodiments of the present technology can be useful for indexing and searching videos stored on a local computing apparatus (a hard drive, a server or the like) or a remote computing apparatus (server and the like) or a distributed storage (a storage of images distributed amongst a number of servers and the like).

For the purpose of examples to be provided herein below, it shall be assumed that the video repository 110 hosts four videos—a first video 112, a second video 114, a third video 116 and a fourth video 118. Obviously, the four videos depicted herein is not a limiting factor and, as such, in various implementations the video repository 110 will store many more videos in addition to the first video 112, the second video 114, the third video 116 and the fourth video 118.

The source of the video files stored by the video repository 110 is not particularly limited. For example, some or all of the first video 112, the second video 114, the third video 116 and the fourth video 118 may have been uploaded by various users of the system 100. Alternatively, some or all of the first video 112, the second video 114, the third video 116 and the fourth video 118 can be uploaded by an operator of the server 108 (for example, the server 108 can be maintained as part of a video downloading or streamlining service, such as the Netflix service, for example).

In alternative embodiments, the video repository 110 can be a search index of a video vertical or a general search engine. Yet alternatively, the video repository 110 can be maintained by a video aggregator service or the like.

The video files stored by the server 108 (such as the first video 112, the second video 114, the third video 116 and the fourth video 118) do not need to (but can be) all be in the same file format. The video encoding formats used can vary, some examples of the video file format include but are not limited to: Audio Video Interleaved (AVI), Windows Media Video (WMV), MPEG, GIF, Advanced Systems Format (ASF), and the like. In alternative embodiments, the server can maintain multiple versions of the same video file, each video file of the multiple versions being encoded in accordance with its respective encoding standard.

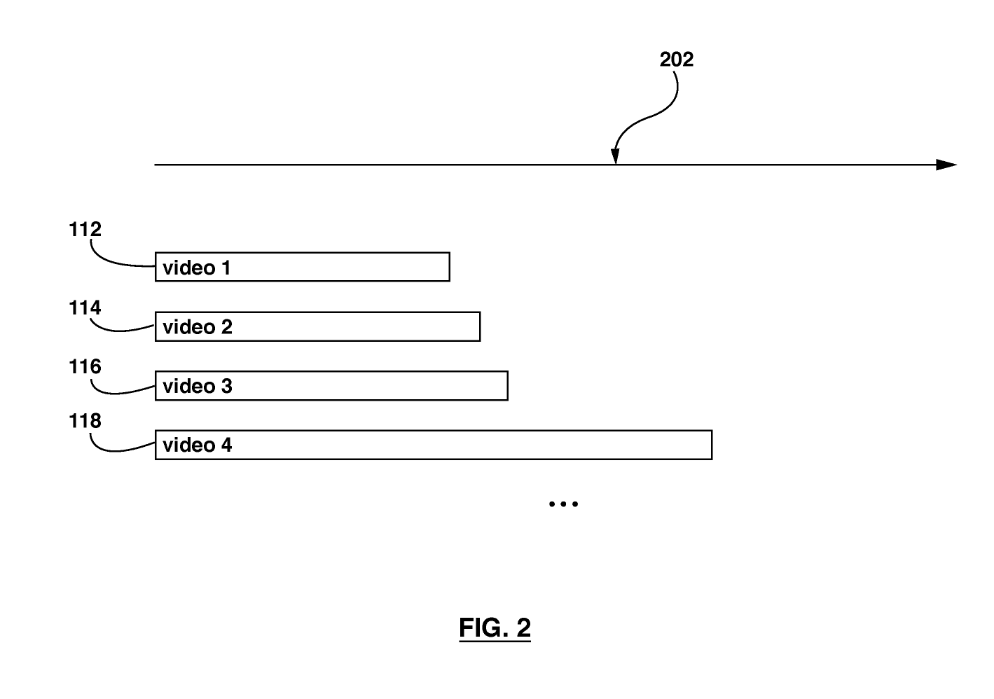

Each of the first video 112, the second video 114, the third video 116 and the fourth video 118 is associated with duration—i.e. a time indication of the length of the respective one of the first video 112, the second video 114, the third video 116 and the fourth video 118. As an example only, with reference to FIG. 2, there is depicted a schematic illustration of respective durations of the first video 112, the second video 114, the third video 116 and the fourth video 118 relative to a timescale 202 (expressed in minutes, hours, etc). For illustration purposes only, it shall be assumed that the respective durations of the first video 112, the second video 114, the third video 116 and the fourth video 118 are as follows: the first video 112 is nineteen minutes, the second video 114 is forty nine minutes, the third video 116 is fifty minutes, and the fourth video 118 is hundred minutes.

In the illustration of FIG. 2, the first video 112, the second video 114, the third video 116 and the fourth video 118 are illustrated organised in accordance with the duration, in an ascending order from the first video 112 to the fourth video 118. It should be expressly understood that there is no limitation for the video repository 110 to maintain the first video 112, the second video 114, the third video 116 and the fourth video 118 in any particular order of the length of duration (or any other particular order).

As such, the video repository 110 can maintain the first video 112, the second video 114, the third video 116 and the fourth video 118 in a chronological order of uploading, the chronological order of when the particular video was created, by genre, by source, by a user identifier of the user who uploaded the video file and the like.

The electronic device 102 comprises hardware and/or software and/or firmware (or a combination thereof), as is known in the art, to execute a video indexing application 104. The video indexing application 104 is configured to create, maintain, access and search a processed video information database 120.

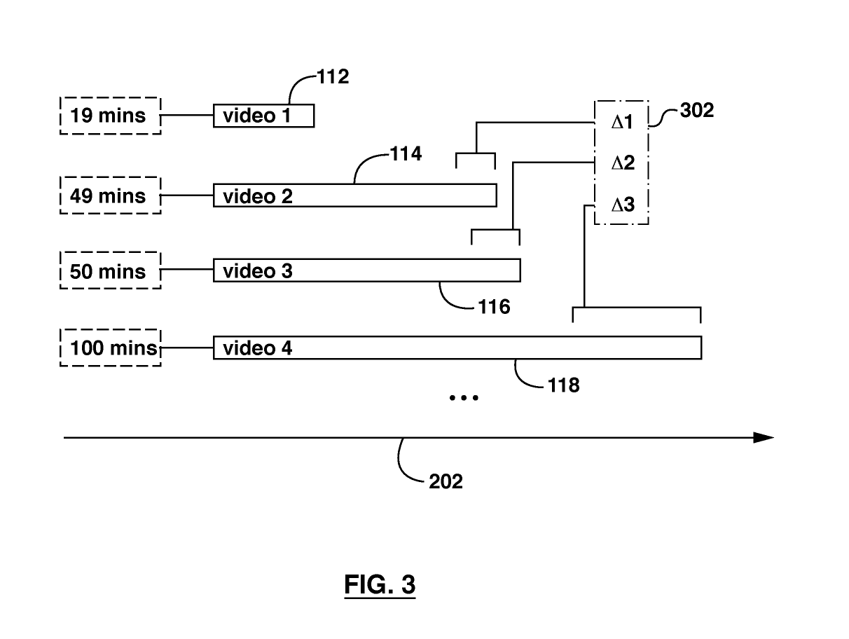

With reference to FIG. 3, which schematically depicts the first video 112, the second video 114, the third video 116 and the fourth video 118 with processing data overlaid over them, the processing data as determined by the video indexing application 104.

First, we shall address how the video indexing application 104 generates a variance parameter. As has been aluded to above, the variance parameter is calculated for each video file, i.e. for each of the first video 112, the second video 114, the third video 116 and the fourth video 118. In other words, for a given collection of video files (including the first video 112, the second video 114, the third video 116 and the fourth video 118 and other video files) the variance parameter for each video file in the collection is calculated independently for each given video file.

Furthermore, when describing the analysis routines below and when viewed from the perspective of the collection of video files as a whole (including the first video 112, the second video 114, the third video 116 and the fourth video 118 and other video files), the variance parameter can be said to be “dynamic” Dynamic, as used herein, is meant to denote the fact that the variance parameter is not pre-determined for all of the video files within the collection of video files, but is rather calculated individually for each video files for which the near-duplicates are to be analyzed. As can be seen in FIG. 3, respective variance parameters (depicted by square brackets and the associated calculation routines at 302) for the second video 114, the third video 116 and the fourth video 118 are different therebetween.

For a given one of the first video 112, the second video 114, the third video 116 and the fourth video 118 and other video files, the variance parameter is calculated as follows. The video indexing application 104 determines the duration of the given video (i.e. one of the first video 112, the second video 114, the third video 116 and the fourth video 118). The video indexing application 104 then determines the variance window.

In some embodiments of the present technology, the variance window can be determined based on a window variance parameter, which can be expressed as a percentage and can be pre-determined to be 5%. The value of 5% is used as an example only and other values are possible. In some embodiments, the value of the variance window parameter is determined empirically.

The video indexing application 104 first determines the variance window. Using the second video 114 as an example and recalling that the second video 114 duration is forty nine minutes, the video indexing application 104 determines the variance window as follows:

Δ1=0.05*49 min=2.45 min (Formula 1)

Where Δ1 is the variance window and 0.05 is the variance window parameter of 5%.

Next, the video indexing application 104 determines a lower limit and an upper limit of the variance parameter. In some embodiments, the upper limit is set as the duration of the given video. In the example of the second video 114, the upper limit is set as follows: t2=49 min. The video indexing application 104 calculates the lower limit of the variance parameter as follows:

t2−Δ1=46.15 min (Formula 2)

Where t2 is the duration of the given video (in the example being reviewed here—duration of the second video 114) and Δ1 is the variance window. Hence, for the second video 114, the variance parameter is determined to be between 46.15 minutes and 49 minutes.

It should be understood, however, that the above description is provided as an example only and other ways of determining the variance parameter and/or variance window are possible.

As another example, for the second video 114, an alterative approach to determining the variance parameter can be implemented as follows. In some alternative embodiments of the present technology, the variance window can be determined based on a window variance parameter, which can be expressed as a percentage and can be pre-determined to be 5%. The value of 5% is used as an example only and other values are possible. In some embodiments, the value of the window variance parameter is determined empirically.

The video indexing application 104 first determines the variance window. Using the second video 114 as an example and recalling that the second video 114 duration is forty nine minutes, the video indexing application 104 determines the variance window as follows:

Δ1=0.05*49 min=2.45 min (Formula 1)

Where Δ1 is the variance window.

The video indexing application 104 can determine the lower limit of the variance parameter substantially as has been described above:

t2−Δ1=46.15 min (Formula 2)

Where t2 is the duration of the given video (in the example being reviewed here—duration of the second video 114) and Δ1 is the variance window.

In some embodiments, the upper limit is determined as follows:

t2+Δ1=51.45 min (Formula 3)

Hence, for the second video 114, within these embodiments, the variance parameter is determined to be between 46.15 minutes and 51.45 minutes.

Naturally, yet other variations are possible. For example, rather than a percentage, the variance window parameter can be expressed as a constant value, such as 15 seconds, 30 seconds, 1 minute and the like.

Additionally, where the lower limit and the upper limit of the variance parameter is calculated, the variance window used for the determination of the upper limit and the lower limit does not need to be the same. For example, a first variance window of 5% can be applied for determining the lower limit, while a second variance window of 3% can be applied for determining the upper limit (or vice versa).

As another example, a first variance window of 60 seconds can be applied for determining the lower limit, while a second variance window of 1.5 minutes can be applied for determining the upper limit (or vice versa).

Naturally, the exact values of the respective first and second variance windows can vary and can be determined empirically based on analysis of the effect of upper/lower limits variations on likelihood of near-duplicate candidate videos actually being the near-duplicate videos.

An example of a process for comparing candidate near-duplicate videos will be described momentarily. Broadly speaking, however, if a duration of a given near-duplicate video falls within the variance parameter, the given near duplicate video is considered to be an actual near-duplicate video candidate and is selected for further analysis (by means of bit-by-bit comparison, video signature comparison and the like).

In some embodiments of the present technology the routine for selecting near-duplicate video candidates can be implemented as follows. It is noted that the routine for selecting near-duplicate video candidates can be executed by the video indexing application 104.

Ranking/Organizing Step

In some embodiments of the present technology, the first video 112, the second video 114, the third video 116 and the fourth video 118 are first ranked/organized in an order of the length of the duration. In some embodiments, the video indexing application 104 ranks/organizes the first video 112, the second video 114, the third video 116 and the fourth video 118 in an ascending order of the duration, as depicted in FIG. 2, for example.

Iterative Near-Duplicate Candidate Determination Process

Next, the video indexing application 104 starts an iterative near-duplicate candidate determination process.

The second video 114 is selected as a given video for which near-duplicate video candidates are to be selected. The video indexing application 104 then determines the variance parameter for the second video 114, as has been described in detail above. It will be recalled that in a given example, the variance parameter for the second video 114 has been determined to be 46.15 minutes and 49 minutes. Since the duration of the first video 112 is nineteen minutes (t1=19 min), the video indexing application 104 determines that the duration of the first video 112 is below the lower limit of the variance parameter of the second video 114 (and thus is outside of the variance parameter of the second video 114). Thus, the video indexing application 104 does not select the first video 112 as an actual near-duplicate candidate for the second video 114.

The video indexing application 104 then selects the third video 116 as the given video for which near-duplicate video candidates are to be selected. Akin to the process of determining the variance parameter described above the video indexing application 104 determines the variance window as follow: Δ2=0.05*50 min=2.5 min. The video indexing application 104 then determines the upper limit and the lower limit of the variance parameter for the third video 116. The video indexing application 104 determines the upper limit of the variance parameter to be the duration of the third video 116 (t3=50 min) and the lower limit of the variance parameter is determined as, t3−Δ2=47.5 min. Thus, the variance parameter for the third video 116 is set as between 47.5 m min and 50 min.

Next, the video indexing application 104 determines which ones of the potential near-duplicate video candidates are actual near-duplicate video candidates for the second video 114. Returning to the example presented herein, the duration of the first video 112 is t1=19 min, which is below the lower limit of the third video 116, thus the video indexing application 104 determines that the first video 112 is not an actual near-duplicate candidate for the third video 116.

For the second video 114, the duration thereof is above the lower limit of the variance parameter and below the upper limit of the variance parameter, thus the video indexing application 104 determines that the duration of the second video 114 is within the variance parameter of the third video 116, thus, the video indexing application 104 selects the second video 114 as an actual candidate for being a near-duplicate of the third video 116.

Once the second video 114 is determined to be an actual near-duplicate candidate for the third video 116, the video indexing application 104 then determines if the second video 114 is actually a near-duplicate of the third video 116. In some embodiments of the present technology, the video indexing application 104 can compare a video signature of the second video 114 with a video signature of the third video 116. In those embodiments, where video signatures are made up of signature visual words, the video indexing application 104 determines a number of overlapping signature visual words between the signature of the second video 114 and the signature of the third video 116.

In response to the number of overlapping signature visual words being above a pre-determined matching threshold, the video indexing application 104 determines that the second video 114 is actually a near-duplicate of the third video 116.

In some additional embodiments of the present technology, in addition to or instead of the video signatures, the video indexing application 104 can compare audio tracks of the second video 114 and the third video 116. In some additional embodiments of the present technology, the video indexing application 104 can additionally compare titles of the second video 114 and the third video 116. In some additional embodiments of the present technology, the video indexing application 104 can additionally compare other metadata of the second video 114 and the third video 116.

The video indexing application 104 then repeats the process with the fourth video 118, as well as other videos potentially present within the collection.

It is noted that the videos that were not determined to actually be near-duplicate video candidates (such as the first video 112) are not compared with the target video, thus, potentially leading to saved time and/or saved computing resources.

In those embodiments of the present technology, where the video files have been ranked in an ascending order of video duration, an additional technical effect of reducing computational resources required can be achieved by comparing either only lower duration videos (where the upper limit of the variance parameter is set at the given video duration) or lower duration videos and immediately following longer duration videos (where the upper limit of the variance parameter is set using the variance window parameter).

In some embodiments of the present technology, the video indexing application 104, once it selects all the near-duplicates for the given video, can execute one or more actions in relation to the given video and/or some or all of its near-duplicate videos.

In some embodiments, the video indexing application 104 “merges” the given video and at least some of its identified near-duplicate videos. How the video indexing application 104 executes the merging is not particularly limited and can include one or more of the following actions.

The video indexing application 104 can merge the metadata associated with the given video and at least some of its identified near-duplicate videos. The metadata can include description, titles, audio tracks and the like.

The video indexing application 104 can merge the video signature associated with the given video and at least some of its identified near-duplicate videos. For example, video words (i.e. visual words) from the video signature of the given video can be added to the video signature of the at least some of its identified near-duplicates and vice versa.

In some embodiments of the present technology, the video indexing application 104 can create a cluster containing the given video and at least some of its identified near-duplicates. The so-created cluster can include a cluster ID, as well as links (such as URLs or the like) to the given video and at least some of its identified near-duplicates. The video indexing application 104 can store the cluster information in the above mentioned processed video information database 120.

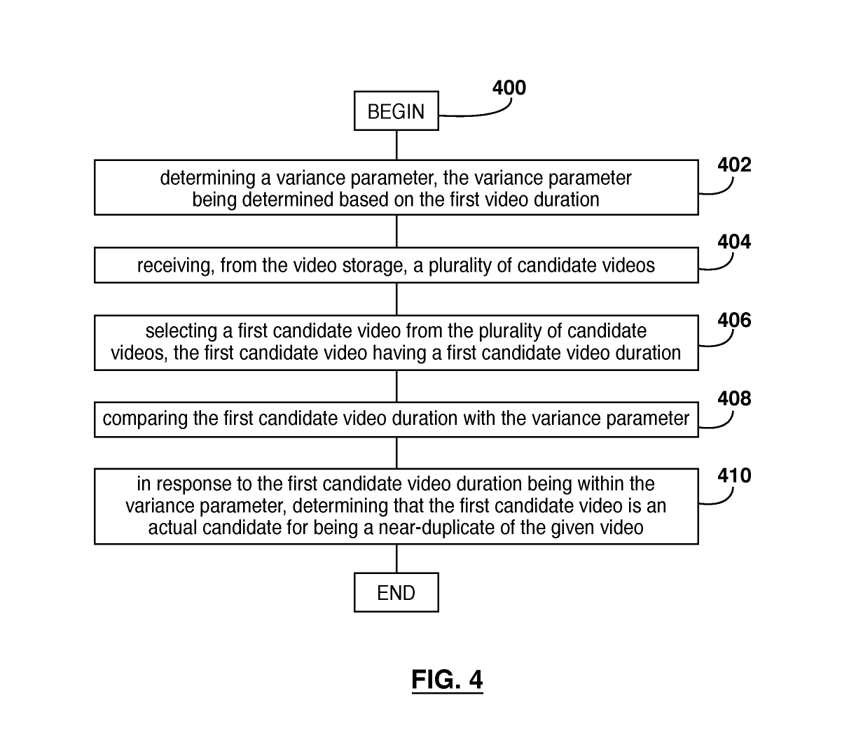

Given the architecture and examples provided herein above, it is possible to execute a method of selecting a candidate video (the candidate video potentially being a near-duplicate of a given video, the given video having a given video duration). With reference to FIG. 4, there is depicted a block diagram of a method 400 of selecting near-duplicate video candidates, the method being implemented in accordance with non-limiting embodiments of the present technology. The method 400 can be executed by a computing apparatus, for example, by the electronic device 102. More specifically, the method 400 can be executed by the video indexing application 104.

Step 402—Determining a Variance Parameter, the Variance Parameter Being Determined Based on the First Video Duration

The method 400 starts at step 402, where the video indexing application 104 determines a variance parameter, the variance parameter being determined based on the first video duration (in this case, the first video duration is the duration of the video for which the near-duplicate videos are to be determined).

In some embodiments of the method 400, the variance parameter comprises: as an upper limit of variance, the first video duration; as a lower limit, a value that is the first video duration less a pre-determined variance window.

In some embodiments of the method 400, the variance parameter comprises: as an upper limit of variance, a value that is the first video duration plus a pre-determined variance window; as a lower limit, a value that is the first video duration less the pre-determined variance window.

Step 404—Receiving, from the Video Storage, a Plurality of Candidate Videos

At step 404, the video indexing application 104 receives, from the video repository 110, a plurality of candidate videos.

Step 406—Selecting a First Candidate Video from the Plurality of Candidate Videos, the First Candidate Video Having a First Candidate Video Duration

At step 406, the video indexing application 104 selects a first candidate video from the plurality of candidate videos, the first candidate video having a first candidate video duration.

In some embodiments of the method 400, selecting the first candidate video from the plurality of candidate videos comprises: ranking the plurality of candidate videos in an order of respective candidate video duration and selecting the first video candidate being a video candidate with a lowest duration.

Step 408—Comparing the First Candidate Video Duration with the Variance Parameter

At step 408, the video indexing application 104 compares the first candidate video duration with the variance parameter.

Step 410—in Response to the First Candidate Video Duration Being within the Variance Parameter, Determining that the First Candidate Video is an Actual Candidate for Being a Near-Duplicate of the Given Video

At step 410, in response to the first candidate video duration being within the variance parameter, the video indexing application 104 determines that the first candidate video is an actual candidate for being a near-duplicate of the given video.

Once the video indexing application 104 determines that the first candidate video is an actual candidate for being a near-duplicate of the given video, the method 400 further comprises comparing the first candidate video with the given video to determine if the first candidate video being the near-duplicate of the given video.

In some embodiments of the meth video storage (108) od 400, the given video comprises a given video signature and the first candidate video comprising a first candidate video signature. Within these embodiments, the video indexing application 104 can compare the first candidate video with the given video by comparing the first candidate video signature and the given video signature. The comparing the first candidate video signature and the given video signature can be executed in a bit-by-bit manner

In some embodiments of the method 400, the video indexing application 104 the can additionally (or alternatively) compare at least one of: audio tracks, meta data, and titles for the given video and the first candidate video.

In some embodiments of the method 400, the method 400 further comprises: selecting a second candidate video from the plurality of candidate videos, the second candidate video having a second candidate video duration; comparing the second candidate video duration with the variance parameter; if the second candidate video duration is outside the variance parameter, determining that the second candidate video is not an actual candidate for being a near-duplicate of the given video. In some embodiments of the method 400, the method 400 further comprises comparing the first candidate video with the given video (as it has been determined to be the actual candidate for being near-duplicate video) and not comparing the second candidate video with the given video (as it has been determined not to be the actual candidate for being near-duplicate video).

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method of selecting a candidate video, the candidate video potentially being a near-duplicate of a given video, the given video having a given video duration, the method executed at an electronic device, the electronic device having access to a video storage, the method comprising:
determining a variance parameter, the variance parameter being determined based on the first video duration;
receiving, from the video storage, a plurality of candidate videos;
selecting a first candidate video from the plurality of candidate videos, the first candidate video having a first candidate video duration;
comparing the first candidate video duration with the variance parameter;
in response to the first candidate video duration being within the variance parameter, determining that the first candidate video is an actual candidate for being a near-duplicate of the given video.

2. The method of claim 1, further comprising comparing the first candidate video with the given video.

3. The method of claim 2, wherein the given video comprises a given video signature and the first candidate video comprises a first candidate video signature; wherein the comparing the first candidate video with the given video comprises comparing the first candidate video signature and the given video signature.

4. The method of claim 3, wherein comparing the first candidate video signature and the given video signature is executed in a bit-by-bit manner.

5. The method of claim 3, further comprising comparing at least one of: audio tracks, meta data, and titles for the given video and the first candidate video.

6. The method of claim 1, further comprising:
selecting a second candidate video from the plurality of candidate videos, the second candidate video having a second candidate video duration;
comparing the second candidate video duration with the variance parameter;
if the second candidate video duration is outside the variance parameter, determining that the second candidate video is not an actual candidate for being a near-duplicate of the given video.

7. The method of claim 5, further comprising:
comparing the first candidate video with the given video;
not comparing the second candidate video with the given video.

8. The method of claim 1, wherein the variance parameter comprises:
as an upper limit of variance, the first video duration;
as a lower limit, a value that is the first video duration less a pre-determined variance window.

9. The method of claim 1, wherein the variance parameter comprises:
as an upper limit of variance, a value that is the first video duration plus a pre-determined variance window;
as a lower limit, a value that is the first video duration less the pre-determined variance window.

10. The method of claim 1, further comprising comparing the first candidate video with the given video to determine if the first candidate video being the near-duplicate of the given video.

11. The method of claim 9, in response to the first candidate video being the near-duplicate of the given video, executing at least one action with at least one of: the first candidate video and the given video.

12. The method of claim 1, wherein selecting the first candidate video from the plurality of candidate videos comprises:
ranking the plurality of candidate videos in an order of respective candidate video duration;
selecting the first video candidate being a video candidate with a lowest duration.

13. An electronic device comprising:
a communication interface for communication via a communication network with a video storage, the video storage hosting a plurality of videos,
a processor operationally connected with the communication interface, the processor configured to:
receive, from the video storage, a plurality of candidate videos; a candidate video of the plurality of candidate videos potentially being a near-duplicate of a given video, the given video having a given video duration;
determine a variance parameter, the variance parameter being determined based on the first video duration;
select a first candidate video from the plurality of candidate videos, the first candidate video having a first candidate video duration;
compare the first candidate video duration with the variance parameter;
in response to the first candidate video duration being within the variance parameter, determine that the first candidate video is an actual candidate for being a near-duplicate of the given video.

14. The system of claim 13, the processor being further configured to compare the first candidate video with the given video.

15. The electronic device of claim 14, wherein the given video comprises a given video signature and the first candidate video comprises a first candidate video signature; wherein to compare, the processor is configured to compare the first candidate video signature and the given video signature.

16. The electronic device of claim 15, wherein comparing the first candidate video signature and the given video signature is executed in a bit-by-bit manner.

17. The electronic device of claim 13, the processor being further configured to:
select a second candidate video from the plurality of candidate videos, the second candidate video having a second candidate video duration;
compare the second candidate video duration with the variance parameter;
if the second candidate video duration is outside the variance parameter, to determine that the second candidate video is not an actual candidate for being a near-duplicate of the given video.

18. The electronic device of claim 17, the processor being further configured to:
compare the first candidate video with the given video;
not compare the second candidate video with the given video.

19. The electronic device of claim 13, wherein to select the first candidate video from the plurality of candidate videos, the processor is configured to:
rank the plurality of candidate videos in an order of respective candidate video duration;
select the first video candidate being a video candidate with a lowest duration.
